(19) United States
(12) Patent Application Publication
(10) Pub. No.: US 2026/0022597 A1
(43) Pub. Date: Jan. 22, 2026

(54) STORAGE CONTAINER

(71) Applicant: Tenma Corporation, Tokyo (JP)

(72) Inventor: Wataru Ishizuka, Tokyo (JP)

(21) Appl. No.: 19/270,979

(22) Filed: Jul. 16, 2025

(30) Foreign Application Priority Data
Jul. 18, 2024 (JP) 2024-114486

(51) Int. Cl. E05C 3/22; A47B 88/473

(52) U.S. Cl. CPC E05C 3/22; A47B 88/473

(57) ABSTRACT

A storage container includes a drawer, a support portion that slidably supports the drawer, and a lock mechanism that locks the drawer. The drawer includes a box main body and a front side plate portion. The lock mechanism includes a rotation member, a locked portion, and an operation member. The rotation member is positioned on a rear side of the front side plate portion. The operation member is exposed on a front side of the front side plate portion and is connected to the rotation member through an opening penetrating the front side plate portion. The operation member further closes the opening of the front side plate portion.

### PRIORITY CLAIM

This application claims the benefit of the filing date of Japanese Patent Application Serial No. 2024-114486, filed Jul. 18, 2024, for “Storage Container.”

### TECHNICAL FIELD

This disclosure relates to a storage container that stores an object to be stored.

### BACKGROUND

In the related art, various storage containers have been used to store an object to be stored. Japanese Patent No. 4956050 discloses a storage container including a drawer and a support portion that slidably supports the drawer, the drawer being configured to be locked in the support portion. In the storage container of Japanese Patent No. 4956050, a movable handle portion, a protruding portion, and a biasing member that are integrally formed are rotatably supported to the drawer, and the protruding portion is biased by the biasing member and is inserted into a fitted portion of the support portion in a state in which the drawer is put into the support portion. As a result, the drawer is locked in the support portion. In addition, the user rotates the movable handle portion against the biasing force of the biasing member, such that the protruding portion is pulled out from the fitted portion and the lock on the drawer is released.

### BRIEF SUMMARY

In the storage container of Japanese Patent No. 4956050, an opening (handle cutout) is formed in a front side plate portion of a drawer for exposing the movable handle portion to the front side. However, the back side (rear side) of the front side plate portion being seen from the front side of the drawer through the opening of the front side plate portion is not preferable in terms of the exterior design of the storage container. That is, there is room for improvement in the exterior design of the storage container as viewed from the front surface side of the drawer.

In view of the above circumstances, an object of the disclosure is to provide a storage container capable of improving an exterior design as viewed from a front surface side of a drawer.

This disclosure provides a storage container that stores an object to be stored, the storage container includes a drawer for storing the object to be stored, a support portion that slidably supports the drawer, and a lock mechanism that locks the drawer in the support portion.

The drawer includes a box main body that stores the object to be stored, and a front side plate portion that is positioned on a front side of the box main body in a direction in which the drawer is pulled out from the support portion.

The lock mechanism includes a rotation member that has a protrusion portion and is rotatably attached to the box main body, a locked portion that is provided on the support portion and is locked by the protrusion portion to lock the drawer in the support portion, and an operation member that is movably attached to the front side plate portion and is operated by a user to rotate the rotation member from a locking position where the protrusion portion is locked to the locked portion to a retraction position where the protrusion portion is not locked to the locked portion.

The rotation member is positioned on a rear side of the front side plate portion in a pull-out direction of the drawer.

The operation member is exposed on a front side of the front side plate portion and is connected to the rotation member through an opening penetrating the front side plate portion and further closes the opening of the front side plate portion.

According to the storage container of the disclosure, since the opening of the front side plate portion of the drawer is closed by the operation member, the exterior design of the storage container as viewed from the front surface side of the drawer can be improved.

### BRIEF DESCRIPTION OF THE DRAWINGS

FIG. 1 is a perspective view showing a storage container according to a first embodiment of the disclosure.

FIG. 2 is an exploded perspective view showing a part of the storage container of FIG. 1 in an exploded manner.

FIG. 3 is a cross-sectional view showing a main part of the storage container of FIG. 1.

FIG. 4 is a perspective view showing a rotation member, a biasing member, an operation member, and a finger hook member in FIG. 3.

FIG. 5 is an exploded perspective view in which the rotation member and the operation member of FIG. 4 are disposed to be separated from each other.

FIG. 6 is a diagram for describing an operation of a lock mechanism in the first embodiment.

FIG. 7 is a diagram for describing the operation of the lock mechanism in the first embodiment.

FIG. 8 is a perspective view showing a storage container according to a second embodiment of the disclosure in an exploded manner.

FIG. 9 is a perspective view showing a main part of the storage container of FIG. 8.

FIG. 10 is a cross-sectional view showing a main part of the storage container of FIG. 8.

FIG. 11 is an exploded perspective view in which the rotation member and the operation member of FIGS. 9 and 10 are disposed to be separated from each other.

FIG. 12 is a diagram for describing an operation of a lock mechanism in the second embodiment.

FIG. 13 is a diagram for describing the operation of the lock mechanism in the second embodiment.

FIG. 14 is a perspective view showing a storage container according to a third embodiment of the disclosure in an exploded manner.

FIG. 15 is a cross-sectional view showing a main part of the storage container of FIG. 14.

FIG. 16 is a perspective view showing the rotation member and the operation member of FIG. 15.

FIG. 17 is a diagram for describing an operation of a lock mechanism in the third embodiment.

FIG. 18 is a diagram for describing the operation of the lock mechanism in the third embodiment.

### DETAILED DESCRIPTION

### First Embodiment

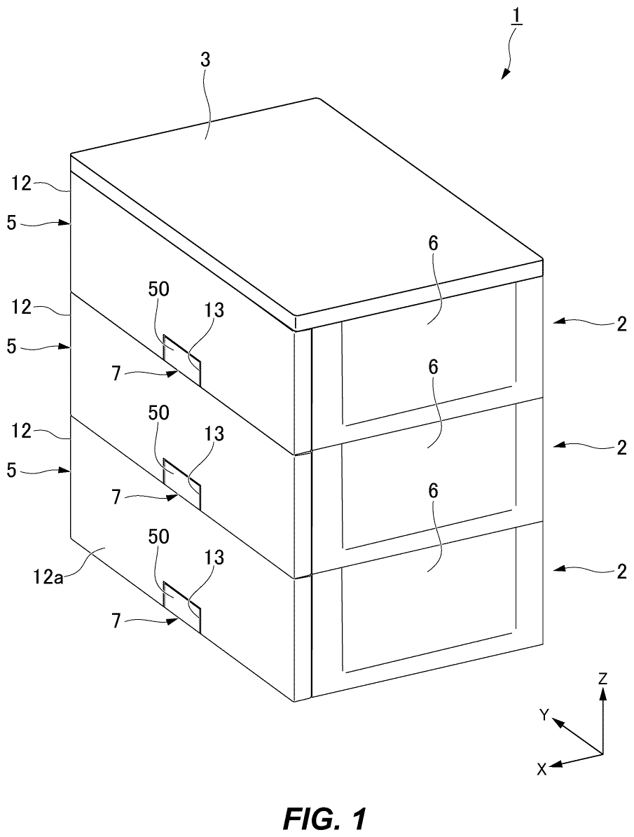

Hereinafter, a first embodiment of the disclosure will be described with reference to FIGS. 1 to 7. In the following description, the same reference numerals are assigned to the configurations corresponding to each other, and the description of the overlapping part may be omitted. Further, for example, expressions indicating relative or absolute dispositions such as “parallel,” “orthogonal,” and “center” not only strictly represent such dispositions but also represent a state in which there is a relative displacement with angles and distances that allow for tolerances and achieve the same function.

As shown in FIG. 1, a storage container 1 according to the present embodiment is configured by laminating a plurality of rectangular box-shaped containers 2 in an up-down direction Z. A top plate portion 3 that covers an upper side of the container 2 is provided on a top surface of the container 2 positioned at the uppermost portion.

Since the configurations of the plurality of containers 2 to be laminated are the same, one container 2 will be described below.

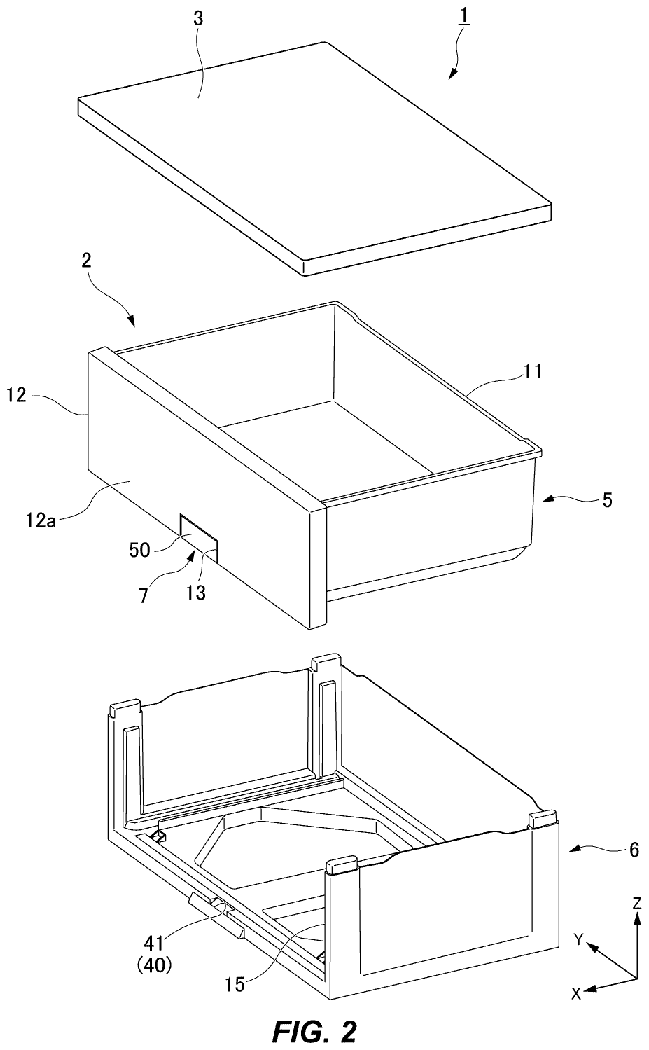

As shown in FIGS. 1 and 2, the container 2 includes a drawer 5 that stores an object to be stored (not shown), a support portion 6 that slidably supports the drawer 5, and a lock mechanism 7 that locks the drawer 5 in the support portion 6. In the present embodiment, the slide direction of the drawer 5 with respect to the support portion 6 is the front-rear direction X orthogonal to the up-down direction Z.

In the drawings, the direction orthogonal to the up-down direction Z and the front-rear direction X corresponds to the width direction Y of the container 2 (storage container 1). In the following description, a side to which an arrow in the up-down direction Z points (+Z side) is referred to as an “upper side,” and a side opposite to the side to which the arrow in the Z direction points (−Z side) is referred to as a “lower side.”. In addition, a side to which the arrow in the front-rear direction X points (+X side) is referred to as a “front side,” and a side opposite to the side to which the arrow in the front-rear direction X points (−X side) is referred to as a “rear side.”

As shown in FIG. 2, the drawer 5 includes a box main body 11 and a front side plate portion 12.

The box main body 11 is formed in a box shape that is open on the upper side. An object to be stored is stored in the box main body 11. The box main body 11 of the present embodiment has a substantially rectangular parallelepiped appearance having sides extending in three directions of the up-down direction Z, the front-rear direction X, and the width direction Y.

The front side plate portion 12 is positioned on the front side of the box main body 11 in a direction in which the drawer 5 is pulled out from the support portion 6 (the pull-out direction of the drawer 5). The front side plate portion 12 covers the box main body 11 from the front side.

The pull-out direction of the drawer 5 is a direction toward the front side (+X side) in the front-rear direction X. The front side plate portion 12 is mainly formed in a flat plate shape in which the front-rear direction X is the plate thickness direction. The front side plate portion 12 in the example shown in the drawing is formed in a rectangular shape having a long side in the width direction Y as viewed in the front-rear direction X. The front side plate portion 12 may be formed separately from the box main body 11, for example, or may be formed integrally with the box main body 11.

The front side plate portion 12 is formed with an opening 13 penetrating in a plate thickness direction. In the present embodiment, the opening 13 of the front side plate portion 12 is open at a lower end of the front side plate portion 12. The opening 13 of the front side plate portion 12 in the example shown in the drawing is formed in a rectangular shape having the long side in the width direction Y as viewed from the front-rear direction X, and is positioned at the center of the front side plate portion 12 in the width direction Y.

The support portion 6 is formed in a box shape that accommodates the box main body 11 of the drawer 5. The support portion 6 is formed in a rectangular parallelepiped shape corresponding to the box main body 11. The support portion 6 has an opening portion 15 that is open on the front side (in the pull-out direction). The support portion 6 of the present embodiment is also open on the upper side.

The above-described drawer 5 is slidable in the front-rear direction X with respect to the support portion 6 such that the box main body 11 enters and exits the support portion 6 through the opening portion 15 of the support portion 6.

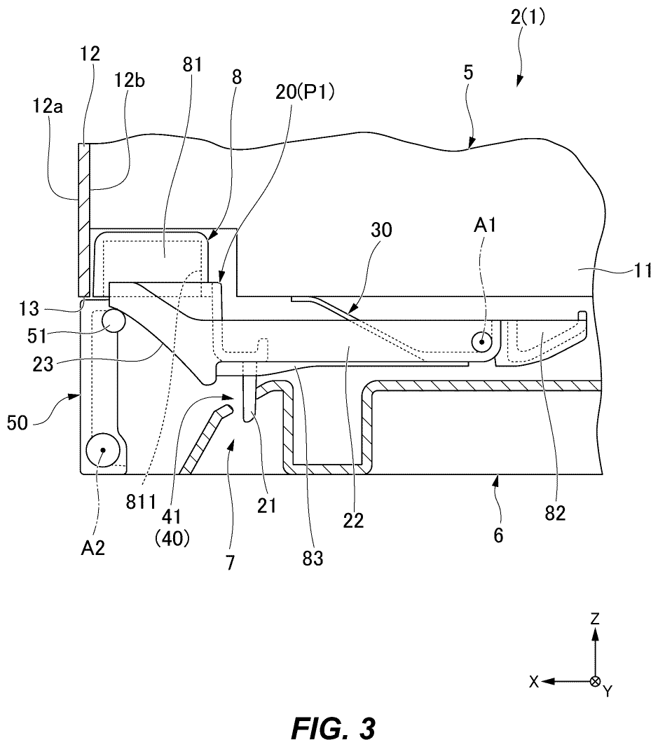

As shown in FIG. 3, the lock mechanism 7 includes a rotation member 20 having a protrusion portion 21, a biasing member 30, a locked portion 40, and an operation member 50.

The rotation member 20 is rotatably attached to the box main body 11 and is positioned on a rear side of the front side plate portion 12 in the front-rear direction X (pull-out direction).

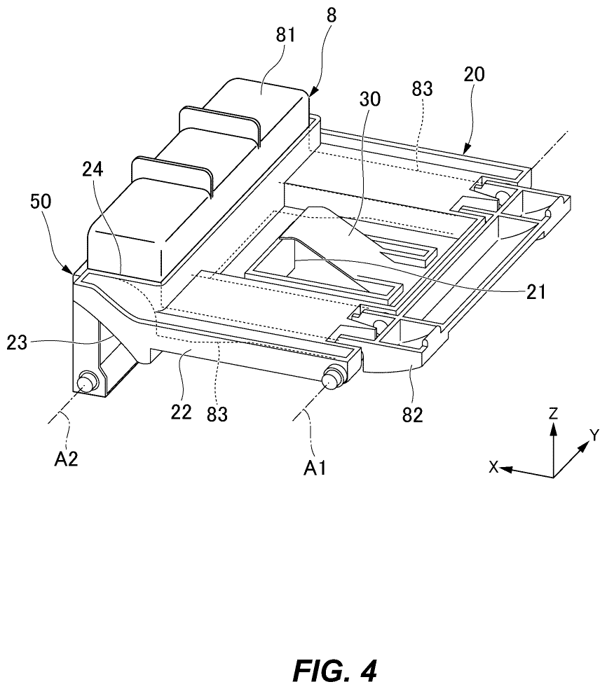

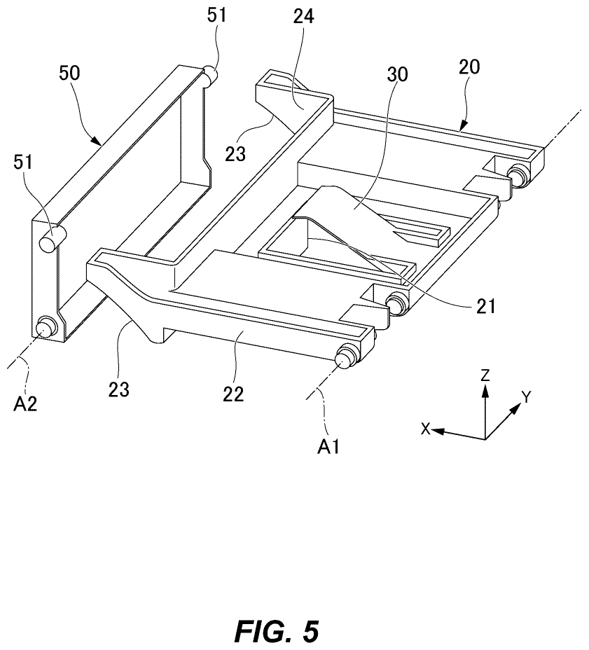

As shown in FIGS. 4 and 5, the rotation member 20 of the present embodiment has a main body portion 22 extending in the front-rear direction X. The main body portion 22 of the example shown in the drawing is formed in a shape that also extends in the width direction Y.

As shown in FIGS. 3 to 5, the protrusion portion 21 of the rotation member 20 is integrally formed with the main body portion 22 and protrudes downward (−Z side) from the main body portion 22. The protrusion portion 21 is positioned at an intermediate portion of the main body portion 22 in the width direction Y. In addition, the protrusion portion 21 is positioned close to an end portion (front end portion) of the main body portion 22 on the front side but is shifted from the front end portion to the rear side.

A sliding surface 23 is formed at the front end portion of the main body portion 22. The sliding surface 23 is a surface on which a sliding portion 51 of the operation member 50 slides with the movement of the operation member 50, which will be described later. The sliding surface 23 is a surface facing the lower side (−Z side) and is mainly inclined downward toward the rear side (−X side). The sliding surface 23 is provided at both end portions of the main body portion 22 in the width direction Y. The sliding surface 23 in FIGS. 3 to 5 is concavely curved in the inclination direction but may be flat, for example.

In the example shown in the drawing, a recessed portion 24 recessed to the rear side is formed at a front end portion of the main body portion 22.

The recessed portion 24 is positioned between the two sliding surfaces 23 in the width direction Y.

As shown in FIG. 3, the rotation member 20 is disposed on a lower side of the box main body 11. The rotation member 20 is rotatably attached to the box main body 11 about a first rotation axis A1 extending in the width direction Y at a rear end portion (an end portion on the rear side) of the main body portion 22. The rotation member 20 is attached to a position corresponding to the opening 13 of the front side plate portion 12 in the width direction Y in the box main body 11, that is, is positioned at the center of the box main body 11 in the width direction Y.

Both the protrusion portion 21 and the sliding surface 23 of the rotation member 20 described above are positioned away from the first rotation axis A1 toward the front end portion side of the main body portion 22.

The biasing member 30 is provided between the rotation member 20 and the box main body 11 and biases the rotation member 20 in a direction away from the box main body 11. Specifically, the biasing member 30 biases the rotation member 20 to the lower side of the box main body 11. The biasing member 30 is positioned away from the first rotation axis A1 of the rotation member 20 toward the front end portion side of the main body portion 22. The biasing member 30 of the present embodiment is a leaf spring that is integrally formed with the main body portion 22 of the rotation member 20.

As shown in FIGS. 2 and 3, the locked portion 40 is provided on the support portion 6, and the protrusion portion 21 of the rotation member 20 is locked to the locked portion 40 to lock the drawer 5 in the support portion 6. The locked portion 40 of the present embodiment is the locking hole 41 into which the protrusion portion 21 is inserted. The locking hole 41 is open on the upper side at the bottom portion of the support portion 6 that supports the box main body 11 from the lower side. The protrusion portion 21 is inserted into the locking hole 41 from the upper side.

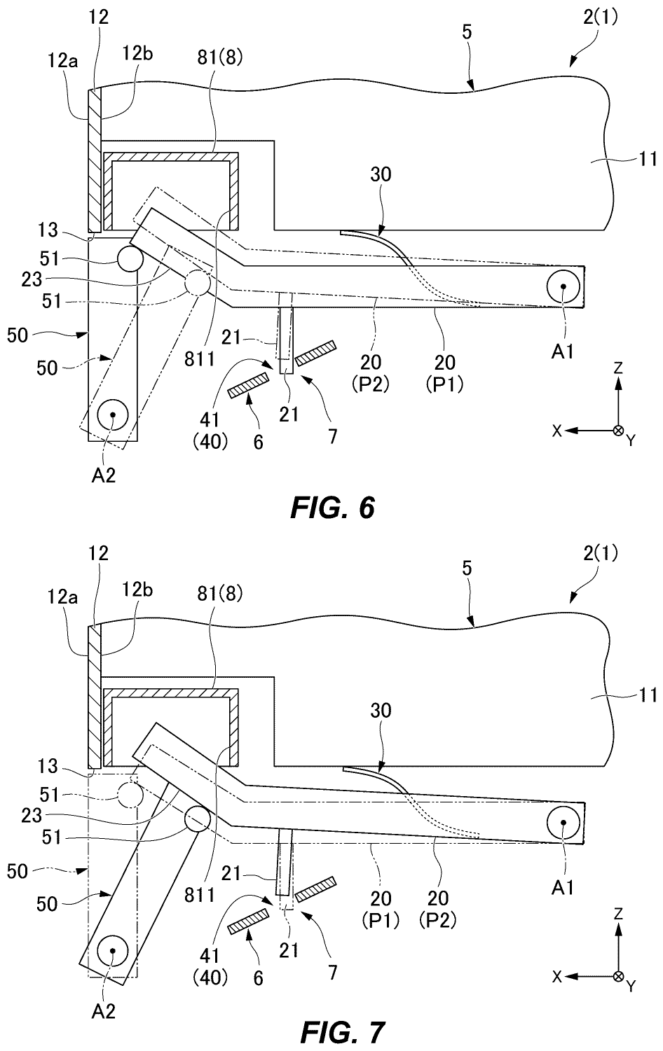

The operation member 50 is movably attached to the front side plate portion 12. As shown in FIGS. 6 and 7, the operation member 50 is operated by the user to rotate the rotation member 20 from a locking position P1 where the protrusion portion 21 is locked to the locked portion 40 to a retraction position P2 where the protrusion portion 21 is not locked to the locked portion 40. The operation member 50 is exposed to the front side of the front side plate portion 12 and is connected to the rotation member 20 through the opening 13 penetrating the front side plate portion 12. In addition, the operation member 50 closes the opening 13 of the front side plate portion 12. The operation member 50 and the rotation member 20 are not limited to being always connected and may be connected at least in a case of moving the protrusion portion 21 from the locking position P1 to the retraction position P2. Therefore, the operation member 50 and the rotation member 20 may be temporarily separated from each other, for example, in a process of operating the operation member 50 by the user.

Hereinafter, the operation member 50 of the present embodiment will be further described.

As shown in FIG. 5, the operation member 50 of the present embodiment is formed in a substantially flat plate shape. The shape and size of the operation member 50 as viewed from the plate thickness direction correspond to the shape and size of the opening 13 of the front side plate portion 12. That is, the shape of the operation member 50 as viewed from the plate thickness direction is formed in a rectangular shape having the long side in the width direction Y.

Therefore, as shown in FIG. 2, the operation member 50 can close the opening 13 of the front side plate portion 12. In addition, in a state in which the operation member 50 is disposed at a position where the opening 13 of the front side plate portion 12 is closed, the operation member 50 is flush with a front surface 12a of the front side plate portion 12.

As shown in FIG. 3, the operation member 50 is rotatably attached to the front side plate portion 12 about a second rotation axis A2 (rotation axis) extending in an orthogonal direction orthogonal to the slide direction (front-rear direction X) of the drawer 5. The “orthogonal direction” in the present embodiment is the width direction Y. In addition, the second rotation axis A2 is positioned at a lower end of the opening 13 of the front side plate portion 12. Although not shown, in the present embodiment, the rotational movement of the operation member 50 with respect to the front side plate portion 12 is restricted such that the operation member 50 does not come out to the front side with respect to the front surface 12a of the front side plate portion 12. As a result, the operation member 50 can be rotationally moved only to the rear side of the front side plate portion 12 from the position where the opening 13 of the front side plate portion 12 is closed.

As shown in FIGS. 3 and 5, the operation member 50 includes the sliding portion 51. The sliding portion 51 slides on the sliding surface 23 of the rotation member 20 in accordance with the rotational movement of the operation member 50. The sliding portion 51 is positioned away from the second rotation axis A2 as viewed in the width direction Y. In FIG. 3, the sliding portion 51 is positioned at an upper end portion of the operation member 50 and comes into contact with the sliding surface 23 of the rotation member 20 that faces downward. The sliding portion 51 is positioned at both end portions of the operation member 50 in the width direction Y to correspond to each of the two sliding surfaces 23 of the rotation member 20.

As shown in FIGS. 3 and 6, in a state in which the operation member 50 is disposed at a position where the opening 13 of the front side plate portion 12 is closed, the rotation member 20 is disposed at the locking position P1. Then, as shown in FIG. 7, the operation member 50 is rotated with respect to the front side plate portion 12 such that the operation member 50 moves to the rear side of the front side plate portion 12, to move the rotation member 20 from the locking position P1 to the retraction position P2.

In this case, the rotation member 20 moves upward toward the retraction position P2 from the locking position P1 and approaches the box main body 11. Therefore, the biasing member 30 is elastically deformed to bias the rotation member 20 in a direction from the retraction position P2 to the locking position P1. In addition, the operation member 50 connected to the rotation member 20 is also biased by the biasing member 30 toward a position where the opening 13 of the front side plate portion 12 is closed.

As shown in FIGS. 3 and 4, the container 2 of the present embodiment further includes a handle member 8. The handle member 8 is disposed at a position corresponding to the rotation member 20. That is, similarly to the rotation member 20, the handle member 8 is positioned on the lower side of the box main body 11 on the rear side of the front side plate portion 12 and is further positioned at the center of the box main body 11 in the width direction Y. The handle member 8 is attached to the drawer 5 in a non-movable manner. In addition, the handle member 8 is attached to the drawer 5 not to rotate with respect to the drawer 5 about the first rotation axis A1. The handle member 8 is configured by integrally forming a finger hook portion 81, an attachment portion 82, and a connection portion 83.

The finger hook portion 81 has an insertion recess portion 811 into which a finger of the user is inserted in a case in which the user pulls out the drawer 5 to the front side. In the present embodiment, the finger hook portion 81 is positioned adjacent to an upper portion of the opening 13 in a rear surface 12b of the front side plate portion 12, and the insertion recess portion 811 is open downward. The finger hook portion 81 is disposed in the recessed portion 24 formed at the front end portion of the main body portion 22 of the rotation member 20, that is, is positioned between the two sliding surfaces 23 in the width direction Y. The finger hook portion 81 of the present embodiment is formed in a wide shape having a long width in the width direction Y.

The attachment portion 82 is positioned at an interval on a rear side of the finger hook portion 81. The above-described rotation member 20 is rotatably attached to the attachment portion 82 about the first rotation axis A1. That is, the rotation member 20 is rotatable with respect to both the box main body 11 and the handle member 8 about the first rotation axis A1. The attachment portion 82 of the present embodiment is formed in a wide shape that is long in the width direction Y, similarly to the finger hook portion 81.

The connection portion 83 extends in the front-rear direction X and connects the finger hook portion 81 and the attachment portion 82 to each other. In the present embodiment, the connection portion 83 is positioned on a lower side of the main body portion 22 of the rotation member 20. In addition, the connection portion 83 is positioned on both sides of the protrusion portion 21 in the width direction Y not to interfere with the protrusion portion 21 of the rotation member 20. These two connection portions 83 connect both end portions of the finger hook portion 81 and both end portions of the attachment portion 82 in the width direction Y.

Next, the action of the storage container 1 in the first embodiment will be described.

As shown in FIGS. 3 and 6, in a state in which the drawer 5 is put into the support portion 6, the rotation member 20 is positioned at the locking position P1, and thus the protrusion portion 21 of the rotation member 20 is locked to the locked portion 40 of the support portion 6, specifically, the protrusion portion 21 is inserted into the locking hole 41 of the support portion 6. As a result, the drawer 5 is locked in the support portion 6. In addition, in this state, the operation member 50 is disposed at a position where the opening 13 of the front side plate portion 12 is closed.

In order to pull out the drawer 5 from the support portion 6 to the front side, first, the user operates the operation member 50 such that the upper end portion of the operation member 50 is pushed to the rear side (−X side) with the finger. In this case, as shown in FIG. 7, the operation member 50 is rotated about the second rotation axis A2 positioned at the lower end of the opening 13 of the front side plate portion 12, and the upper end portion of the operation member 50 is positioned to be separated from the opening 13 of the front side plate portion 12 to the rear side, and the upper portion of the opening 13 of the front side plate portion 12 is opened. As a result, the finger of the user can be inserted into the insertion recess portion 811 of the finger hook portion 81 positioned on the rear side of the front side plate portion 12. That is, the user can hook the finger on the finger hook portion 81.

In addition, in a case in which the operation member 50 is rotated about the second rotation axis A2 as described above, the sliding portion 51 of the operation member 50 slides on the sliding surface 23 of the rotation member 20, such that the rotation member 20 is rotated from the locking position P1 to the retraction position P2 against the biasing force of the biasing member 30. As a result, the locking of the protrusion portion 21 to the locked portion 40 is released, and the lock of the drawer 5 is released.

Then, in a state in which the finger of the user is caught in the finger hook portion 81, the user can move the drawer 5 to the front side to pull out the drawer 5 to the front side with respect to the support portion 6.

On the other hand, in a case in which the drawer 5 is moved to the rear side and is put into the support portion 6, as shown in FIG. 6, the rotation member 20 is biased by the biasing member 30 and is disposed at the locking position P1. As a result, the protrusion portion 21 is locked to the locked portion 40, and the drawer 5 is locked in the support portion 6.

The rotation member 20 is not limited to the biasing force of the biasing member 30, and may be automatically moved from the retraction position P2 to the locking position P1 by, for example, the gravity acting on the rotation member 20.

As described above, in the storage container 1 of the first embodiment, in a state in which at least the operation member 50 is not operated by the user, the operation member 50 closes the opening 13 of the front side plate portion 12. Therefore, it is possible to prevent the rear side of the front side plate portion 12 from being seen from the front side of the drawer 5 through the opening 13 of the front side plate portion 12. For example, it is possible to prevent the rotation member 20, the protrusion portion 21, and the biasing member 30, which are positioned on the rear side of the front side plate portion 12, from being seen through the opening 13 of the front side plate portion 12 from the front side of the drawer 5. Therefore, the exterior design of the storage container 1 as viewed from the front side of the drawer 5 can be improved.

In addition, in a state in which the operation member 50 closes the opening 13 of the front side plate portion 12, it is also possible to effectively suppress the user's fingers, articles, and the like from being unexpectedly caught on the rear surface 12b side (back side) of the front side plate portion 12 through the opening 13 of the front side plate portion 12.

Further, in a state in which the operation member 50 closes the opening 13 of the front side plate portion 12, it is possible to prevent dust or the like from entering the rear surface 12b side (back side) of the front side plate portion 12 through the opening 13 of the front side plate portion 12. Therefore, it is possible to suppress the contamination of the rear surface 12b side (back side) portion of the front side plate portion 12.

In addition, in the storage container 1 of the first embodiment, the operation member 50 is disposed at a position where the opening 13 of the front side plate portion 12 is closed in a state in which the rotation member 20 is disposed at the locking position P1 and is flush with the front surface 12a of the front side plate portion 12. In this state, the entire front surface of the drawer 5 can be made a flat surface without unevenness caused by the opening 13 of the front side plate portion 12, and thus the exterior design of the storage container 1 can be further improved.

In addition, in the storage container 1 of the first embodiment, in a state in which the operation member 50 is operated to move the rotation member 20 from the locking position P1 to the retraction position P2, the upper portion of the opening 13 of the front side plate portion 12 is opened, and the upper end portion of the operation member 50 corresponding to the upper portion of the opening 13 of the front side plate portion 12 is positioned to be separated from the opening 13 of the front side plate portion 12 toward the rear side. As a result, the user can easily pull out the drawer 5 to front side from the support portion 6 by inserting the fingers of the user into the rear side of the upper portion of the opening 13 in the front side plate portion 12.

In addition, in the storage container 1 of the first embodiment, the lock mechanism 7 further includes a biasing member 30 that biases the rotation member 20 in a direction from the retraction position P2 toward the locking position P1. Therefore, the biasing force of the biasing member 30 can effectively suppress the lock of the drawer 5 from being unexpectedly released. In addition, after the rotation member 20 is moved from the locking position P1 to the retraction position P2 by operating the operation member 50, the rotation member 20 can be automatically moved from the retraction position P2 to the locking position P1 by the biasing force of the biasing member 30. That is, it is possible to automatically lock the drawer 5.

In addition, in the storage container 1 of the first embodiment, the biasing member 30 is provided between the rotation member 20 and the drawer 5 (box main body 11). Therefore, in a case in which the rotation member 20 is moved from the locking position P1 toward the retraction position P2 in response to the operation of the operation member 50, that is, in a case in which the rotation member 20 approaches the drawer 5, the biasing member 30 is elastically deformed to bias the rotation member 20 in a direction away from the drawer 5. As a result, it is possible to suppress or prevent the rotation member 20 from colliding with the drawer 5. That is, the biasing member 30 also functions as a buffer member that softens the collision between the rotation member 20 and the drawer 5.

### Second Embodiment

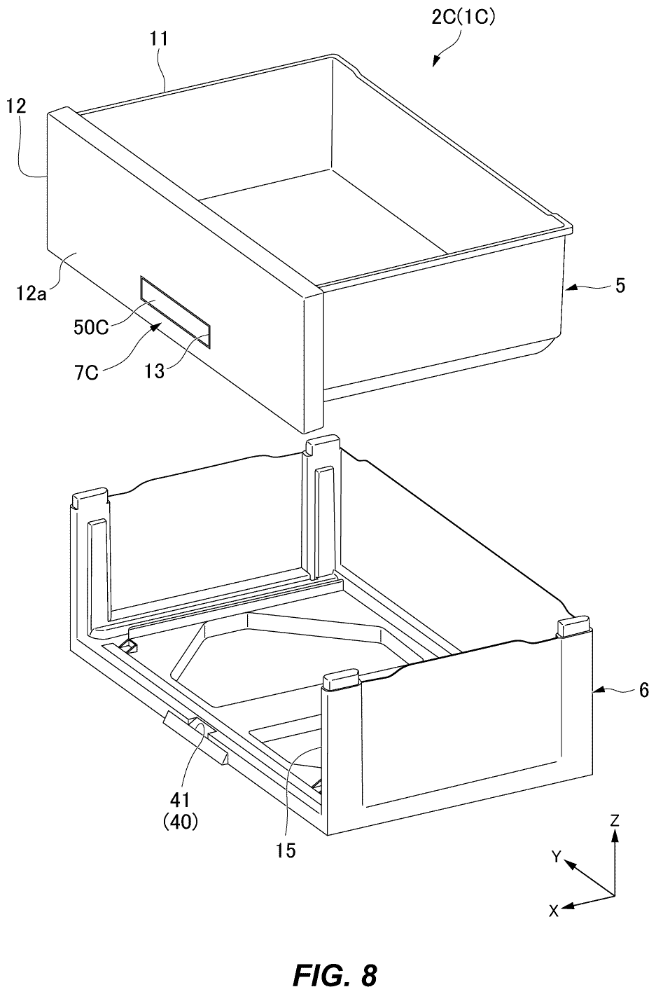

Next, a second embodiment of the disclosure will be described with reference to FIGS. 8 to 13. In the following description, the configurations that are the same as the configurations already described will be given the same reference signs, and duplicate descriptions thereof will be omitted.

The container 2C (storage container 1C) of the second embodiment shown in FIGS. 8 to 13 is different from the first embodiment only in the aspect of the opening 13 of the front side plate portion 12 constituting the drawer 5, the lock mechanism 7C, and the handle member 8.

As shown in FIGS. 8 to 10, the opening 13 of the front side plate portion 12 in the second embodiment is different from that of the first embodiment only in that the opening 13 is not opened at the edge of the front side plate portion 12 as viewed in the front-rear direction X.

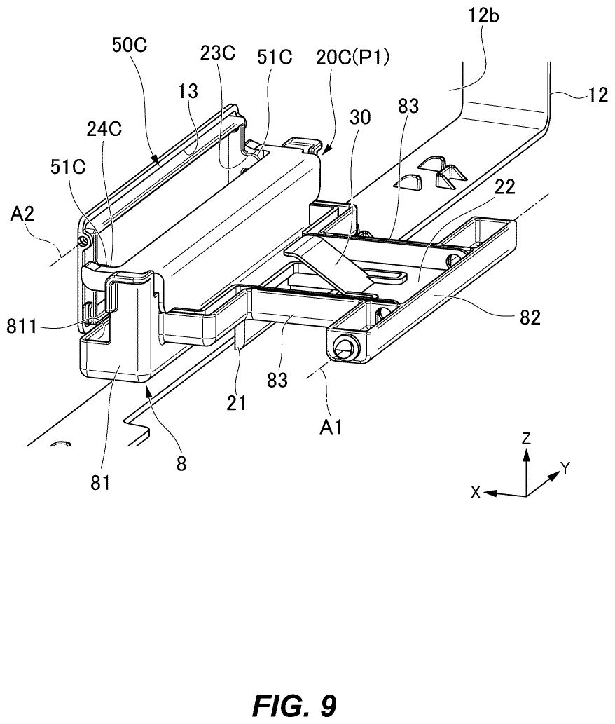

As shown in FIGS. 9 to 11, the lock mechanism 7C of the second embodiment includes a rotation member 20C having a protrusion portion 21, a biasing member 30, a locked portion 40, and an operation member 50C, as in the first embodiment. The biasing member 30 and the locked portion 40 are the same as those in the first embodiment.

The rotation member 20C of the second embodiment has a main body portion 22 extending in the front-rear direction X and the width direction Y, as in the first embodiment. The positions of the protrusion portion 21 and the first rotation axis A1 in the main body portion 22 are also the same as those in the first embodiment.

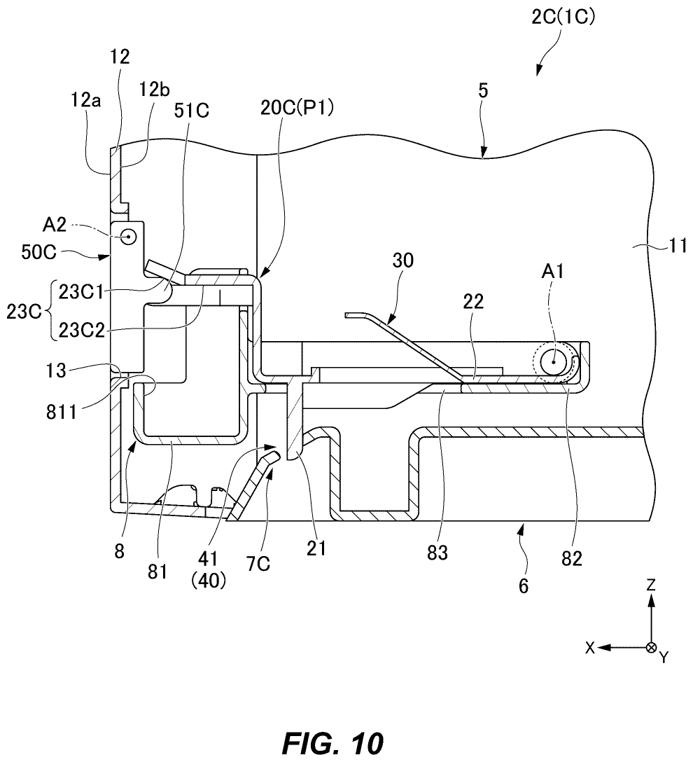

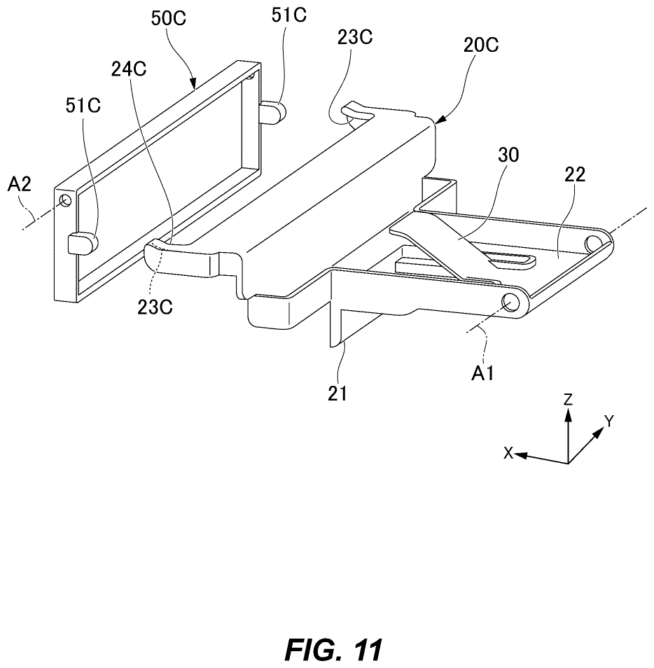

The sliding surface 23C formed at the front end portion of the main body portion 22 is a surface on which the sliding portion 51C of the operation member 50C slides as the operation member 50C moves, as in the first embodiment. As shown in FIG. 10, the sliding surface 23C of the second embodiment faces downward (−Z side). In addition, the sliding surface 23C includes an inclined surface region 23C1 that is inclined downward toward the rear side (−X side) and a parallel surface region 23C2 that is parallel to the front-rear direction X. The parallel surface region 23C2 is connected to a rear end of the inclined surface region 23C1. As shown in FIG. 11, the sliding surface 23C is provided at both end portions of the main body portion 22 in the width direction Y.

As shown in FIGS. 9 and 11, a recessed portion 24C recessed to the rear side is formed at a front end portion of the main body portion 22 including the sliding surface 23C. The recessed portion 24C is positioned between the two sliding surfaces 23C in the width direction Y. The recessed portion 24C is formed to avoid interference between the front end portion of the main body portion 22 and the operation member 50C.

In the example shown in the drawing, the front end portion of the main body portion 22 is positioned to be shifted upward (+Z side) with respect to the other portion of the main body portion 22 including the rear end portion.

As shown in FIGS. 9 to 11, the operation member 50C of the second embodiment is different from that of the first embodiment only in the positions of the second rotation axis A2 and the sliding portion 51C. The second rotation axis A2 of the operation member 50C extends in the width direction Y at the upper end of the opening 13 of the front side plate portion 12.

The sliding portion 51C of the operation member 50C is positioned away from the second rotation axis A2 to the lower side in a state in which the operation member 50C is disposed at a position where the opening 13 of the front side plate portion 12 is closed as shown in FIG. 10. In FIG. 10, the sliding portion 51C is positioned at an intermediate portion of the operation member 50C in the up-down direction Z and protrudes to the rear side with respect to the operation member 50C. The sliding portion 51C comes into contact with the sliding surface 23C of the rotation member 20C facing downward, as in the first embodiment. In addition, as shown in FIG. 11, the sliding portion 51C is positioned at both end portions of the operation member 50C in the width direction Y to correspond to each of the two sliding surfaces 23C of the rotation member 20C.

As shown in FIGS. 9 and 10, the handle member 8 of the second embodiment is configured by integrally forming the finger hook portion 81, the attachment portion 82, and the connection portion 83, as in the first embodiment.

The finger hook portion 81 has the insertion recess portion 811 and is formed in a wide shape that is long in the width direction Y, as in the first embodiment. However, in the second embodiment, the finger hook portion 81 is positioned adjacent to a lower portion of the opening 13 in the rear surface 12b of the front side plate portion 12, and the insertion recess portion 811 is open upward. The finger hook portion 81 is positioned below the front end portion of the main body portion 22 of the rotation member 20C with an interval therebetween.

The aspects of the attachment portion 82 and the connection portion 83 are generally the same as those of the first embodiment.

Next, the action of the storage container 1C in the second embodiment will be described.

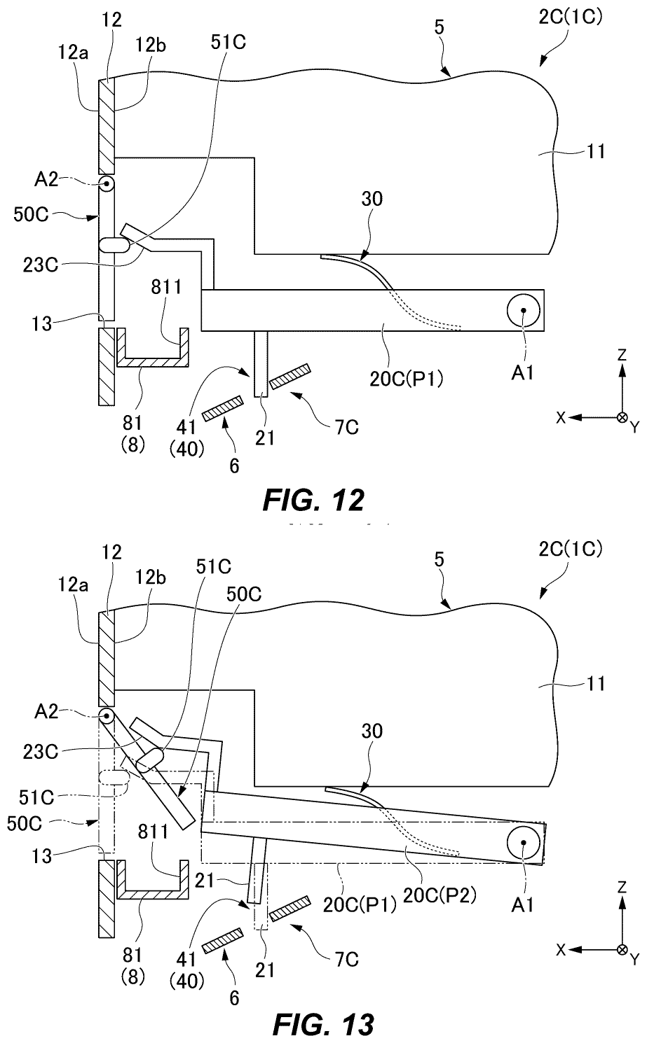

As shown in FIGS. 10 and 12, in a state in which the drawer 5 is put into the support portion 6, as in the first embodiment, the rotation member 20C is positioned at the locking position P1, such that the protrusion portion 21 of the rotation member 20C is locked to the locked portion 40 of the support portion 6, and the drawer 5 is locked in the support portion 6. In addition, in this state, the operation member 50C is disposed at a position where the opening 13 of the front side plate portion 12 is closed.

In order to pull out the drawer 5 from the support portion 6 to the front side, first, the user operates the operation member 50C such that the lower end portion of the operation member 50C is pushed toward the rear side (−X side) with the finger.

In this case, as shown in FIG. 13, the operation member 50C is rotated about the second rotation axis A2 positioned at the upper end of the opening 13 of the front side plate portion 12, and the lower end portion of the operation member 50C is positioned to be separated from the opening 13 of the front side plate portion 12 to the rear side, and the lower portion of the opening 13 of the front side plate portion 12 is opened. As a result, the finger of the user can be inserted into the insertion recess portion 811 of the finger hook portion 81 positioned on the rear side of the front side plate portion 12. That is, the user can hook the finger on the finger hook portion 81.

In addition, as in the first embodiment, the operation member 50C is rotated about the second rotation axis A2, the sliding portion 51C of the operation member 50C slides on the sliding surface 23C of the rotation member 20C, and the rotation member 20C is rotated from the locking position P1 to the retraction position P2. As a result, the lock of the drawer 5 is released. Then, the drawer 5 can be pulled out to the front side with respect to the support portion 6 in a state in which the finger of the user is caught in the finger hook portion 81.

The operation in a case in which the drawer 5 is put into the support portion 6 can be performed in the same manner as in the first embodiment.

The storage container 1C of the second embodiment exhibits the same effects as the first embodiment.

In particular, in the storage container 1C of the second embodiment, in a state in which the operation member 50C is operated to move the rotation member 20C from the locking position P1 to the retraction position P2, the lower portion of the opening 13 of the front side plate portion 12 is opened, and the lower end portion of the operation member 50C corresponding to the lower portion of the opening 13 of the front side plate portion 12 is positioned to be separated from the opening 13 of the front side plate portion 12 toward the rear side. As a result, the user can easily pull out the drawer 5 to front side from the support portion 6 by inserting the fingers of the user into the rear side of the lower portion of the opening 13 in the front side plate portion 12.

In the first and second embodiments, the second rotation axis A2 of the operation members 50 and 50C may extend in the width direction Y in, for example, an intermediate portion of the opening 13 of the front side plate portion 12 in the up-down direction Z.

In addition, in the first and second embodiments, the second rotation axis A2 of the operation members 50 and 50C is not limited to extending in the width direction Y, and may extend in at least an orthogonal direction orthogonal to the slide direction of the drawer 5. Therefore, the second rotation axis A2 may extend in, for example, the up-down direction Z.

Even with these configurations, the same effects as those of the first and second embodiments are obtained.

### Third Embodiment

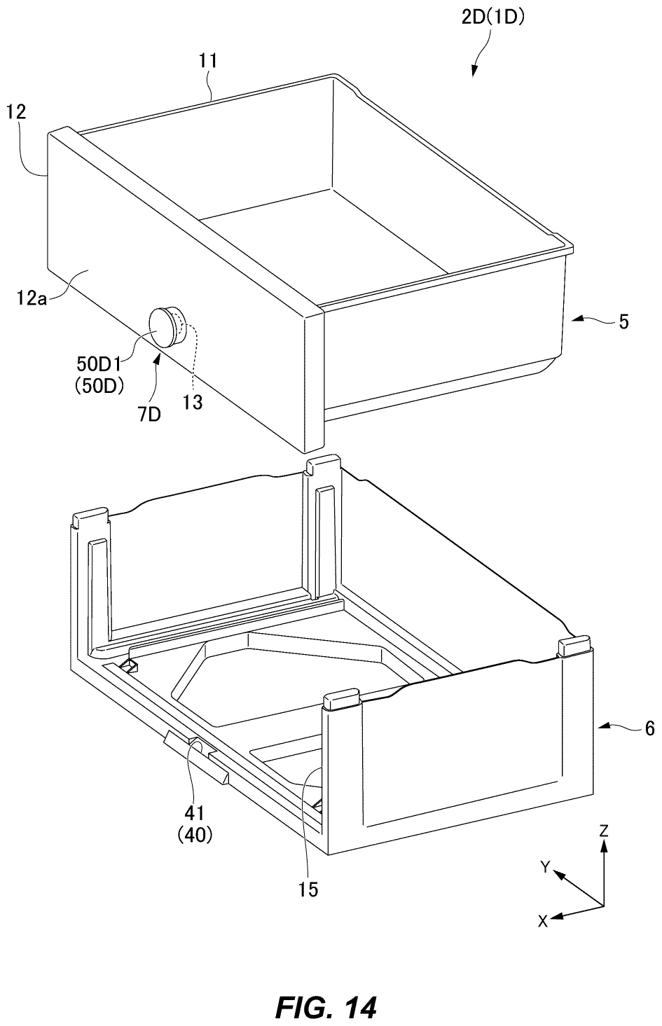

Next, a third embodiment of the disclosure will be described with reference to FIGS. 14 to 18. In the following description, the configurations that are the same as the configurations already described will be given the same reference signs, and duplicate descriptions thereof will be omitted.

The container 2D (storage container 1D) of the third embodiment shown in FIGS. 14 to 18 is different from the first and second embodiments in the aspect of the opening 13 of the front side plate portion 12 constituting the drawer 5 and the aspect of the lock mechanism 7D.

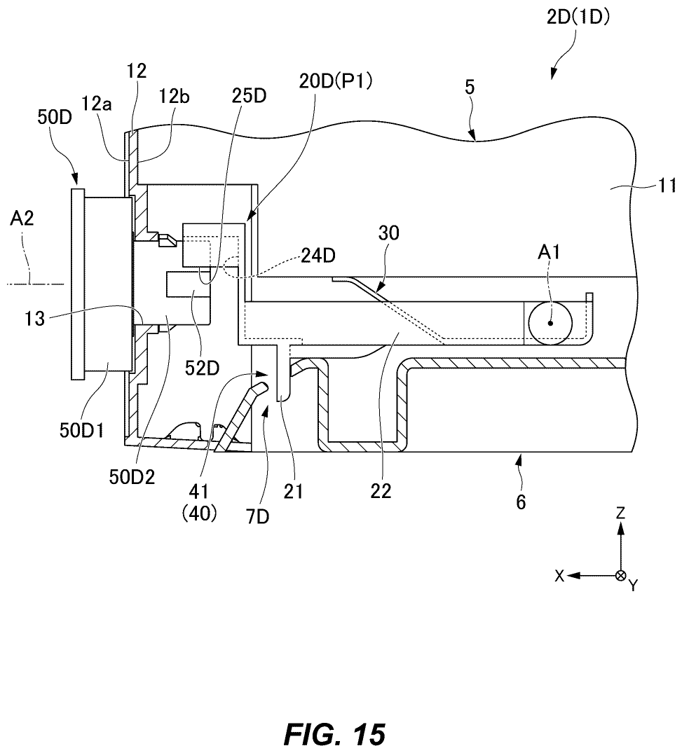

Although not shown, the opening 13 of the front side plate portion 12 in the third embodiment is formed in a circular shape centered on a second rotation axis A2 of an operation member 50D, which will be described later, as viewed in the front-rear direction X. As shown in FIG. 15, an operation member 50D is inserted into the opening 13 of the front side plate portion 12.

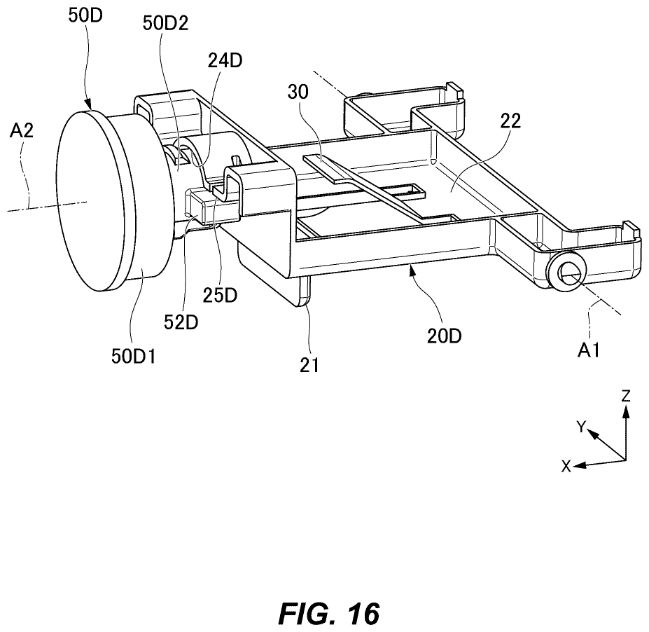

As shown in FIGS. 15 and 16, the lock mechanism 7D of the third embodiment includes a rotation member 20D having a protrusion portion 21, a biasing member 30, a locked portion 40, and an operation member 50D, as in the first embodiment. The biasing member 30 and the locked portion 40 are the same as those in the first embodiment.

The rotation member 20D of the third embodiment has a main body portion 22 extending in the front-rear direction X and the width direction Y, as in the first embodiment. The positions of the protrusion portion 21 and the first rotation axis A1 in the main body portion 22 are also the same as those in the first embodiment.

In the third embodiment, a pressed surface 25D is formed at a front end portion of the main body portion 22.

The pressed surface 25D is a surface that is pressed by a pressing protrusion 52D of the operation member 50D, which will be described later, as the operation member 50D is moved. The pressed surface 25D faces downward (−Z side).

In addition, a recessed portion 24D recessed to the upper side is formed at a front end portion of the main body portion 22. The recessed portion 24D is positioned adjacent to the pressed surface 25D in the width direction Y. A part of a rear portion 50D2 of an operation member 50D, which will be described later, is accommodated in the recessed portion 24D. Although not shown, the above-described pressed surface 25D is positioned on both sides of the recessed portion 24D in the width direction Y.

In the example shown in the drawing, the front end portion of the main body portion 22 is positioned to be shifted upward (+Z side) with respect to the other portion of the main body portion 22 including the rear end portion.

The basic disposition, function, and role of the operation member 50D of the third embodiment are the same as those of the first embodiment.

The operation member 50D of the third embodiment has a substantially columnar appearance and is disposed such that an axial direction thereof is directed in the front-rear direction X. A diameter dimension of a front portion 50D1 of the operation member 50D in the front-rear direction X is larger than a diameter dimension of the rear portion 50D2 of the operation member 50D. The operation member 50D penetrates the opening 13 of the front side plate portion 12 and is rotatably attached to the front side plate portion 12 about a second rotation axis A2 extending in the front-rear direction X. Specifically, the rear portion 50D2 of the operation member 50D is inserted into the opening 13 of the front side plate portion 12 from the front side of the front side plate portion 12, such that the operation member 50D is rotatably attached to the front side plate portion 12.

The front portion 50D1 of the operation member 50D is positioned on the front surface 12a side of the front side plate portion 12 and functions as a knob portion that is pinched by a finger of a user. The front portion 50D1 of the operation member 50D is larger than the opening 13 of the front side plate portion 12 and covers the opening 13 of the front side plate portion 12 from the front side.

A part of the rear portion 50D2 of the operation member 50D is positioned on the rear surface 12b side of the front side plate portion 12. The pressing protrusion 52D is provided on a rear portion 50D2 of the operation member 50D positioned on the rear surface 12b side of the front side plate portion 12. The pressing protrusion 52D protrudes in the radial direction from the rear portion 50D2 of the operation member 50D in a part of the rear portion 50D2 of the operation member 50D in the circumferential direction. Although not shown, two pressing protrusions 52D protrude in opposite directions in the radial direction of the operation member 50D.

The rear portion 50D2 of the operation member 50D positioned on the rear surface 12b side of the front side plate portion 12 is positioned on a lower side of the front end portion of the rotation member 20D. In addition, an upper portion of a rear portion 50D2 of the operation member 50D positioned on the rear surface 12b side of the front side plate portion 12 is accommodated in the recessed portion 24D formed at the front end portion of the rotation member 20D. The pressing protrusion 52D of the operation member 50D is positioned on a lower side of the pressed surface 25D formed at the front end portion of the rotation member 20D. Specifically, each of the two pressing protrusions 52D of the operation member 50D is positioned on the lower sides of the two pressed surfaces 25D positioned on both sides of the recessed portion 24D in the width direction Y.

In the lock mechanism 7D of the third embodiment configured as described above, the operation member 50D is rotated with respect to the front side plate portion 12 about the second rotation axis A2 to move the rotation member 20D from the locking position P1 to the retraction position P2. Hereinafter, this point will be described.

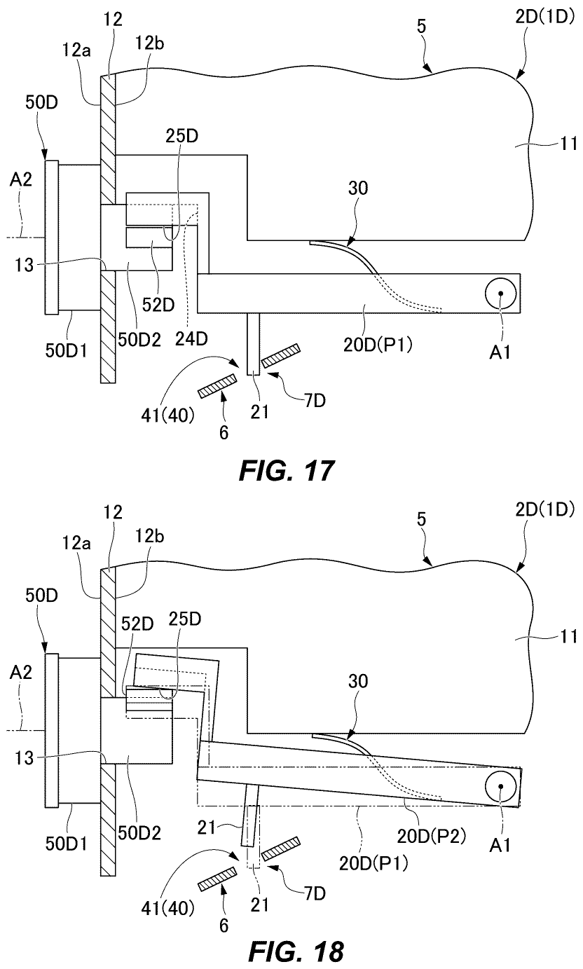

As shown in FIGS. 17 and 18, in a case in which the operation member 50D is rotated about the second rotation axis A2, the pressing protrusion 52D provided on the rear portion 50D2 of the operation member 50D is moved upward and is pressed against the pressed surface 25D of the front end portion of the rotation member 20D. As a result, the front end portion of the rotation member 20D is pushed up to the upper side, and the rotation member 20D is rotated about the first rotation axis A1 from the locking position P1 to the retraction position P2.

In addition, in the lock mechanism 7D of the third embodiment, the pressed surface 25D and the pressing protrusion 52D are positioned on both sides of the second rotation axis A2 in the width direction Y. Therefore, even in a case in which the operation member 50D is rotated to any one side of the rotation direction (for example, clockwise direction) and the other side of the rotation direction (for example, counterclockwise direction), the rotation member 20D can be moved from the locking position P1 to the retraction position P2.

Next, the action of the storage container ID in the third embodiment will be described.

As shown in FIGS. 15 and 17, in a state in which the drawer 5 is put into the support portion 6, as in the first embodiment, the rotation member 20D is positioned at the locking position P1, such that the protrusion portion 21 of the rotation member 20D is locked to the locked portion 40 of the support portion 6, and the drawer 5 is locked in the support portion 6.

In order to pull out the drawer 5 from the support portion 6 to the front side, first, the user operates the front portion 50D1 of the operation member 50D with a finger to rotate the operation member 50D about the second rotation axis A2. In this case, as shown in FIG. 18, the pressing protrusion 52D provided on the rear portion 50D2 of the operation member 50D is moved upward and is pressed against the pressed surface 25D of the front end portion of the rotation member 20D.

Then, the front end portion of the rotation member 20D is pushed up to the upper side, and the rotation member 20D is rotated from the locking position P1 to the retraction position P2. As a result, the lock of the drawer 5 is released, and the drawer 5 can be pulled out to the front side with respect to the support portion 6.

The operation in a case in which the drawer 5 is put into the support portion 6 can be performed in the same manner as in the first embodiment.

The storage container ID of the third embodiment has the same effect as the first embodiment.

In addition, in the storage container 1D of the third embodiment, the rotation member 20D can be easily moved from the locking position P1 to the retraction position P2 only by rotating the operation member 50D.

Although the embodiment according to the disclosure has been described above, the disclosure is not limited to the above-described embodiment and can be appropriately modified without departing from the scope of the disclosure defined in the claims.

In the disclosure, the first rotation axis A1 of the rotation members 20, 20C, and 20D may extend in at least a direction intersecting the slide direction (the front-rear direction X) of the drawer 5. That is, the first rotation axis A1 of the rotation members 20, 20C, and 20D may extend in, for example, the up-down direction Z.

In the disclosure, the front surface 12a of the front side plate portion 12 is not limited to being flat and may be, for example, curved. In addition, the opening 13 of the front side plate portion 12 may be formed in, for example, a curved region of the front surface 12a of the front side plate portion 12. In this case, the operation members 50 and 50C that close the opening 13 of the front side plate portion 12 in the first and second embodiments may have a curved surface that is flush with the curved front surface 12a of the front side plate portion 12.

The storage container of the disclosure is not limited to the configuration in which a plurality of the containers 2 are provided, and, for example, only one container 2 may be provided.

While preferred embodiments of the disclosure have been described and illustrated above, it should be understood that these are exemplary of the disclosure and are not to be considered as limiting. Additions, omissions, substitutions, and other modifications can be made without departing from the scope of the disclosure. Accordingly, the disclosure is not to be considered as being limited by the foregoing description and is only limited by the scope of the appended claims.

What is claimed is:

1. A storage container that stores an object to be stored, comprising:
a drawer for storing the object to be stored;
a support portion configured to slidably support the drawer in a pull-out direction; and
a lock mechanism configured to lock the drawer in the support portion, wherein the drawer comprises:
a box main body configured to store the object to be stored, and
a front side plate portion positioned on a front side of the box main body in the pull-out direction,
the lock mechanism comprises:
a rotation member having a protrusion portion and rotatably attached to the box main body,
a locked portion provided on the support portion and configured to be engaged by the protrusion portion to secure the drawer in the support portion, and
an operation member movably attached to the front side plate portion and operable to rotate the rotation member between a locking position where the protrusion portion is engaged with the locked portion and a retraction position where the protrusion portion is not engaged with the locked portion,
wherein the rotation member is positioned on a rear side of the front side plate portion in the pull-out direction of the drawer, and
wherein the operation member is exposed on a front side of the front side plate portion, is operatively connected to the rotation member through an opening that penetrates the front side plate portion, and is configured to close the opening of the front side plate portion.

2. The storage container according to claim 1,
wherein the operation member is disposed at a position where the opening of the front side plate portion is closed in a state in which the rotation member is disposed at the locking position, and the operation member is flush with a front surface of the front side plate portion.

3. The storage container according to claim 2,
wherein the operation member is rotatably attached to the front side plate portion about a rotation axis extending in a direction orthogonal to a slide direction of the drawer, and
wherein the rotation member is configured to move from the locking position to the retraction position in response to rotation of the operation member from a position where the opening of the front side plate portion is closed to a position where at least a part of the operation member is located on the rear side of the front side plate portion.

4. The storage container according to claim 3,
wherein the rotation axis of the operation member extends in a width direction of the drawer at a lower end of the opening of the front side plate portion.

5. The storage container according to claim 3,
wherein the rotation axis of the operation member extends in a width direction of the drawer at an upper end of the opening of the front side plate portion.

6. The storage container according to claim 1,
wherein the operation member extends through the opening of the front side plate portion and is rotatably attached to the front side plate portion about a rotation axis extending in a slide direction of the drawer, and
wherein the rotation member is configured to move from the locking position to the retraction position in response to rotation of the operation member.

7. The storage container according claim 1,
wherein the lock mechanism further includes a biasing member configured to bias the rotation member in a direction from the retraction position toward the locking position.

8. The storage container according claim 7,
wherein the biasing member is a leaf spring.

9. The storage container according claim 7,
wherein the biasing member s integrally formed with the rotation member.

10. The storage container according claim 7,
wherein the biasing member is configured to bias the rotation member in a direction away from the box main body.

11. The storage container according claim 7,
wherein the biasing member is configured to bias the operation member toward a position where the opening of the front side plate portion is closed.

12. The storage container according claim 7,
wherein the biasing member is configured to function as a buffer member that softens a collision between the rotation member and the box main body when the rotation member approaches the box main body.

13. A storage system comprising a plurality of storage containers, wherein the plurality of storage containers are laminated in an up-down direction, and further comprising a top plate portion covering an upper side of an uppermost storage container,
wherein respective ones of the plurality of storage containers comprise:
a drawer for storing the object to be stored;
a support portion configured to slidably support the drawer in a pull-out direction; and
a lock mechanism configured to lock the drawer in the support portion,
wherein the drawer comprises:
a box main body configured to store the object to be stored, and
a front side plate portion positioned on a front side of the box main body in the pull-out direction,
the lock mechanism comprises:
a rotation member having a protrusion portion and rotatably attached to the box main body,
a locked portion provided on the support portion and configured to be engaged by the protrusion portion to secure the drawer in the support portion, and
an operation member movably attached to the front side plate portion and operable to rotate the rotation member between a locking position where the protrusion portion is engaged with the locked portion and a retraction position where the protrusion portion is not engaged with the locked portion,
wherein the rotation member is positioned on a rear side of the front side plate portion in the pull-out direction of the drawer, and
wherein the operation member is exposed on a front side of the front side plate portion, is operatively connected to the rotation member through an opening that penetrates the front side plate portion, and is configured to close the opening of the front side plate portion.

14. The system of claim 13, wherein respective ones of the plurality of storage containers have uniform dimensions.
